(19) United States
(12) Patent Application Publication
(10) Pub. No.: US 2014/0116333 A1
(43) Pub. Date: May 1, 2014

(54) GLUE ROLLER FOR A LABELING APPARATUS

(71) Applicant: KRONES AG, Neutraubling (DE)

(72) Inventors: Heinz Humele, Thalmassing (DE); Christian Stoiber, Michelsneukirchen (DE); Christian Holzer, Schierling (DE); Ludwig Ferstl, Obertrubling (DE)

(73) Assignee: KRONES AG, Neutraubling (DE)

(21) Appl. No.: 14/056,271

(22) Filed: Oct. 17, 2013

(30) Foreign Application Priority Data
Oct. 25, 2012 (DE) 10 2012 219 552.1

(51) Int. Cl. B65C 9/22

(52) U.S. Cl. CPC B65C 9/2256
USPC 118/258; 228/101; 29/895.2

(57) ABSTRACT

A glue roller for a labeling apparatus including a cylindrical jacket, the top and the bottom openings of which each have a lid plate arranged, where one of the lid plates comprises a gearing for connecting the glue roller with a drive motor, in particular a Hirth-type serration, and the other lid plate comprises one or more elements for connecting the glue roller with a mounting device of a labeling apparatus, and where the one or more elements is arranged on the side of the lid plate facing outwardly.

### CROSS-REFERENCE TO RELATED APPLICATION

The present application claims the benefit of priority of German Application No. 10 2012 219 552.1, filed Oct. 25, 2012. The entire text of the priority application is incorporated herein by reference in its entirety.

### FIELD OF THE DISCLOSURE

The disclosure relates to a glue roller for a labeling apparatus.

### BACKGROUND

Such glue rollers are generally attached to a polygonal shaft which has a ball bearing at the lower end in the housing. The upper end of the shaft has a counter bearing in a hinged lid. To replace the glue roller, the lid is opened and the glue roller is drawn off upwardly from the shaft.

Known glue rollers have an integrated hub with a polygonal profile. The shaft-hub connection should be designed with possibly no tolerance but well detachable. In known glue rollers, this is usually done by the selection of materials. The shaft is typically fabricated from stainless steel, whereas the hub is made of a copper and/or brass alloy.

One disadvantage of the known glue rollers is that they are very heavy due to their internal centering of the cast elements located there. This heavy weight of the glue roller is ergonomically unfavorable because removal, as explained above, requires the glue roller to be lifted.

### SUMMARY OF THE DISCLOSURE

One aspect of the disclosure is to provide a glue roller for a labeling apparatus, which has a lower mass than known glue rollers.

The glue roller according to the disclosure for a labeling apparatus comprises a cylindrical jacket, the top and the bottom openings of which each have a lid plate arranged, where one of the lid plates comprises a gearing for connecting the glue roller with a drive motor, in particular a Hirth-type serration, and where the other lid plate comprises one or more elements for connecting the glue roller with a mounting device of a labeling apparatus, where the one or more elements is/are arranged on a side of the lid plate facing outwardly.

Due to the fact that the lid plates have the gearing or connecting elements, respectively, a shaft for driving the glue roller can be dispensed with. Therefore also the shaft-hub connection can be omitted, which results in the fact that the glue roller can be designed having less mass. This in turn allows for easier replacement of the glue roller and in an ergonomic improvement for the operators.

The glue roller can in particular be a glue roller for transferring hot glue or cold glue onto pallets of a labeling apparatus. The labeling apparatus can be a device for applying labels to containers, in particular to bottles. The labeling apparatus can in particular be a labeling apparatus for the beverage industry.

It is in operating the gluing unit appropriate to arrange the axis of the glue roller, and in particular its longitudinal axis, approximately vertically.

The drive motor can in particular be a servomotor or a stepper motor. This enables individual control of the rotational speed of the glue roller during operation. The individual control of the rotational speed is useful, for example, to achieve precise synchronization between the surface speed of the glue roller and the varying roll-off motion speed of a labeling palette. This in turn can improve the quality of glue transfer.

The outwardly facing side of the lid plate can in particular be a surface area of the lid plate facing away from the interior of the glue roller and is in particular freely accessible from the exterior.

The gearing can in particular be a spur gear ring which can be arranged in particular concentric to the axis of the glue roller. The spur gear ring can be arranged about a central open space. In the area of this open space, the lid plate can comprise a recess. This can further reduce weight. Alternatively, other components can be arranged in the inner open space, for example, for axially securing the engaged rotary coupling between the glue roller and the drive motor.

The gearing can in particular also be disposed on the outwardly facing side of the lid plate, in particular, entirely on the outwardly facing side.

The one or more elements for connecting the glue roller with a mounting device of a labeling apparatus can also be disposed entirely on a side of the lid plate facing outwardly. In other words, the connecting elements in the interior of the glue roller can be omitted.

The gearing can have the same teeth and teeth gaps, respectively, uniformly distributed in the circumferential direction. In this case, an additional positioning device can be provided for a predetermined position of engagement between the gearing of the glue roller and of the gearing of the drive motor. This can be, for example, a centering pin or a receptacle for a centering pin. The respective complementary centering element can be provided at the gearing of the drive motor.

Alternatively, the gearing can also have an irregular arrangement of the teeth. In this case, the irregular arrangement of the teeth can serve to position, since a positive-fit connection to an irregular arrangement of teeth in a gearing of the rotation motor is only possible at one angular position.

The glue roller can also comprise at least one axial locking device securing the glue roller in its axial position in the installed position. The axial locking device can in particular comprise a magnetic and/or ferromagnetic member. For example, one or more teeth of the gearing can be magnetically formed on the one lid plate, for example, as a permanent magnet.

The lid plate for connecting the glue roller with a mounting device can comprise a centering tip or a receiving cone as a counterpart to a centering tip of the mounting device. In other words, the one or more elements for connecting the glue roller to a mounting device can correspond to a centering pin or a receiving cone for a centering pin. By centering, particularly stable mounting is possible.

Foam can be arranged in the interior of the glue roller, in particular where the foam fills the entire cavity in the interior of the glue roller. The foam can increase the stability also of a thin-walled cylindrical jacket, without the weight of the glue roller increasing significantly.

The foam can for example correspond to foamed plastic, in particular polyurethane foam.

The glue roller can be hollow in the interior. In this case, particular weight saving can be achieved.

The cylindrical jacket can have a thickness of 1 mm to 5 mm, in particular 1.5 mm to 3 mm. Such thin-walled design of the jacket can result in further reduction of weight.

The lid plates can be welded to the cylindrical jacket, in particular, be laser-welded.

On the inner side of the cylindrical jacket, one or more stiffening elements can be arranged, in particular stiffening rings. Such stiffening elements can increase the stability of in particular a thin-walled cylindrical jacket. Nevertheless, low weight of the glue roller can be maintained.

The cylindrical jacket can be coated with, in particular, a metallic wear-resistant coating, in particular on its outer side.

At least the outer side of the cylindrical jacket can be, for example, hard-chromed. The hard chromium layer can serve as a wear-resistant coating for the glue roller's contact with a glue wiper when wiping off glue. The cylindrical jacket can also be entirely hard-chromed. Also the lid plates can be partially or entirely hard-chromed.

The hard chromium layer can have a thickness of 30 microns to 60 microns, advantageously from 60 microns to 150 microns.

As an alternative to hard chroming, other coatings and/or hardenings are conceivable. For example, at least the outer side of the cylindrical jacket can be provided with a gel coat layer or a chromium-oxide coating. At least the outer side of the cylindrical jacket can alternatively or additionally also be plasma-nitrided.

The cylindrical jacket can comprise carbon-fiber-reinforced plastic (CFRP—Carbon-fiber-reinforced Plastic) or be composed of carbon-fiber-reinforced plastic. Thereby, a particularly light design of the glue roller is possible. In particular, the cylindrical jacket made of CFRP can also be coated with a metallic wear-resistant coating, for example, an above-mentioned hard chromium layer.

At least one ring-shaped element made of a metal, in particular steel, can be incorporated into the carbon-fiber-reinforced plastic, where the at least one ring-shaped element is disposed in particular in the region of the upper or lower edge of the cylindrical jacket. For precisely wiping off the glue, a sharp edge (if possible with-out a rim) is required at the edges of the cylinder surface. Due to the at least one ring-shaped element, a respectively sharp edge can be enabled.

The two lid plates can have a low thickness or material thickness, in particular between 3 mm and 6 mm.

At least part of the outer side of the cylindrical jacket can be formed such that the surface in this part has a depth of roughness (average depth of roughness Ra) of less than 2 microns, in particular less than 1 micron. A depth of roughness of Ra=0.03 microns to 0.06 microns has been found to be advantageous. In particular, an above-described wear-resistant coating can have said depth of roughness.

The part of the outer side of the cylindrical jacket having said depth of roughness can, in particular, be the part which during operation comes into contact with the glue wiper. With such a smooth surface, uniform application of glue can be achieved. Moreover, such a surface can be easily cleaned. The entire outer side of the cylindrical jacket can also comprise such a depth of roughness.

At least part of the outer side of the cylindrical jacket can be formed such that the surface in this part has a surface hardness of 53 HRC (Rockwell C) to 62 HRC. This can be in particular achieved by a wear-resistant coating described above. A hardness of 68 HRC to 72 HRC has proven advantageous (corresponding to 900 HV (Vickers hardness) to 1200 HV).

The part of the outer side of the cylindrical jacket having said hardness can, in particular, again be the part which during operation comes into contact with the glue wiper. Advantageous abrasion resistance or wear resistance, respectively, can thereby be achieved. Corrosion resistance can also be improved. The entire outer side of the cylindrical jacket can also comprise such a surface hardness.

The disclosure also provides a method of manufacturing a glue roller, in particular a glue roller as described above, comprising the steps of:
providing a cylindrical tube;
connecting, in particular welding, a respective lid plate to the cylindrical tube at each of its two openings;
forming a gearing for connection to a drive motor at a lid plate; and
forming one or more connecting elements for connecting the glue roller with a mounting device of a labeling apparatus on the other lid plate.

Such a method enables manufacturing of a glue roller having a low mass.

The gearing and/or the one or more connecting elements can comprise one or more of the above features. The cylindrical jacket of the glue roller can be formed by the cylindrical tube.

The method can further comprise forming a wear-resistant coating on the outer side of the cylindrical tube. The wear-resistant coating can be in particular a metallic wear-resistant coating.

For example, at least the outer side of the cylindrical jacket can be provided with a gel coat layer or a chromium-oxide coating. At least the outer side of the cylindrical jacket can alternatively or additionally be plasma-nitrided.

The method can in particular comprise hard-chroming of at least the cylindrical tube. In this, in particular the outer side of the cylindrical tube can be chromed. Hard-chroming can be performed before or after connecting the pipe with the lid plates.

The hard chromium layer can have a thickness of 30 microns to 60 microns, advantageously from 60 microns to 150 microns.

Before or after hard-chroming, the cylindrical tube can be ground to a desired wall thickness. At least a steel ring can be wrapped into a cylindrical tube made of carbon-reinforced plastic in a region of an edge of the cylindrical tube. The steel ring can be ground together with the carbon-reinforced plastic to the required diameter.

At least a portion of the outer side of the cylindrical tube can be worked such that it receives a depth of roughness and/or surface hardness as described above.

The method can further comprise arranging foam in the interior of the glue roller, in particular polyurethane foam.

The cylindrical tube can also by turning be given the desired diameter. Turning is here to be understood as a machining method by stock removal. After turning, grinding can take place.

In particular, one or more stiffening elements, in particular stiffening rings, can be arranged on the inner side of the cylindrical tube. The stiffening elements can in particular be welded to the inner side of the cylindrical tube. Such stiffening elements can increase the stability of in particular a thin-walled cylindrical jacket. Nevertheless, low weight of the glue roller can be maintained.

The cylindrical tube can be worked, in particular, such that the cylindrical jacket thus formed comprises one or more of the above features.

In particular, the cylindrical pipe can be worked such that the cylindrical jacket has a thickness of 1 mm to 5 mm, in particular 1.5 mm to 3 mm.

The disclosure also provides a labeling apparatus with the above-described glue roller. The glue roller can comprise one or more of the above-mentioned features.

The labeling apparatus can in particular be a labeling apparatus for labeling containers in the beverage industry, in particular for labeling bottles.

The labeling apparatus can also comprise a palette carousel with a plurality of palette shafts, a label magazine, and an upper gripper cylinder. With these elements, the labels can first be applied glue and then be positioned by the gripper cylinder onto containers, for example bottles. The individual elements of the labeling apparatus can be arranged on a common support structure. It is also possible, however, to mount the main components on their own support structures.

### BRIEF DESCRIPTION OF THE DRAWINGS

Further features and advantages of the disclosure shall be explained below with reference to the figures by way of example.

FIG. 1 shows a perspective view of an example of a gluing unit of a labeling apparatus;

FIG. 2 shows a cross-section through an example of a glue roller;

FIG. 3 shows a cross-section through an example of a glue roller in the installed position in a gluing unit of a labeling apparatus; and

FIG. 4 shows a cross-section through a further example of a glue roller.

### DETAILED DESCRIPTION OF THE PREFERRED EMBODIMENT

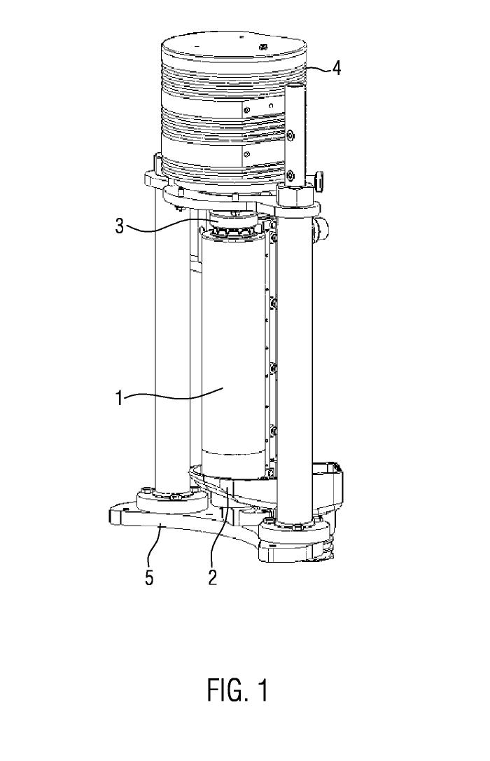

FIG. 1 shows a perspective view of a gluing unit of an example of a labeling apparatus comprising a glue roller 1, which at its lower end 2 is connected to a mounting device. The glue roller 1 is via this mounting device mounted on a support structure 5. A motor 4, in particular a servomotor, is disposed above the glue roller 1. Due to the fact that the motor 4 is arranged above the glue roller 1, it can be avoided that water runs off downwardly during cleaning and passes through a potentially vulnerable rotary seal into the motor 4.

In the upper portion of the glue roller 1, the latter is connected via a rotary coupling 3 to the motor 4. The rotary coupling 3 can in particular be a Hirth-type coupling.

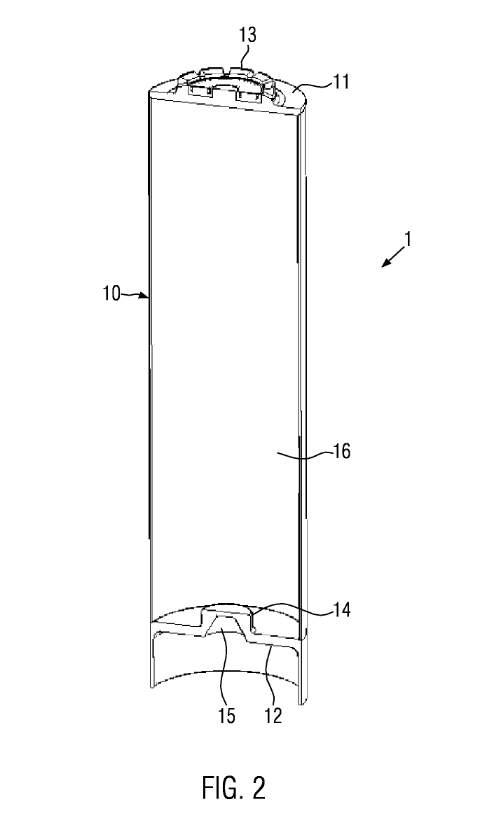

FIG. 2 shows a cross-section through an example of a glue roller, such as can be used in the gluing unit of FIG. 1.

The glue roller can be manufactured, as shown, in particular in a light-weight design. The glue roller 1 comprises a cylindrical jacket 10, which can comprise, for example, steel and/or carbon-fiber-reinforced plastic (CFRP—Carbon-Fiber-Reinforced Plastic). The jacket 10 can be formed in a thin-walled manner, in particular with a thickness or material thickness of 1 mm to 5 mm, in particular from 1.5 mm to 3 mm.

The interior 16 of the glue roller 1 can be hollow. However, the interior space 16 can also be filled with foamed-up material. Due to this foam, additional stabilization of the glue roller 1 can be achieved, yet keeping the weight light.

Lid plates 11, 12 are arranged at the upper and lower ends of the cylindrical jacket 10. Gearing elements 13 are arranged on the upper lid plate 11, in particular a Hirth-type serration, in order to be able to establish a connection with a drive motor. A permanent magnet can also be arranged in the region of the gearing elements 13. It can serve as an axial locking device for the glue roller 1.

In the lower lid plate 12, a receiving cone 14 is provided whose surface 15 serves as a counter-support for a centering tip of a mounting device. At the lower lid plate 12, a wall extension is further connected, which protects the connection region between the glue roller and the mounting device from glue. The wall extension can be integrally formed with the lower lid plate 12 or be connected thereto, in particular in a material-fit manner.

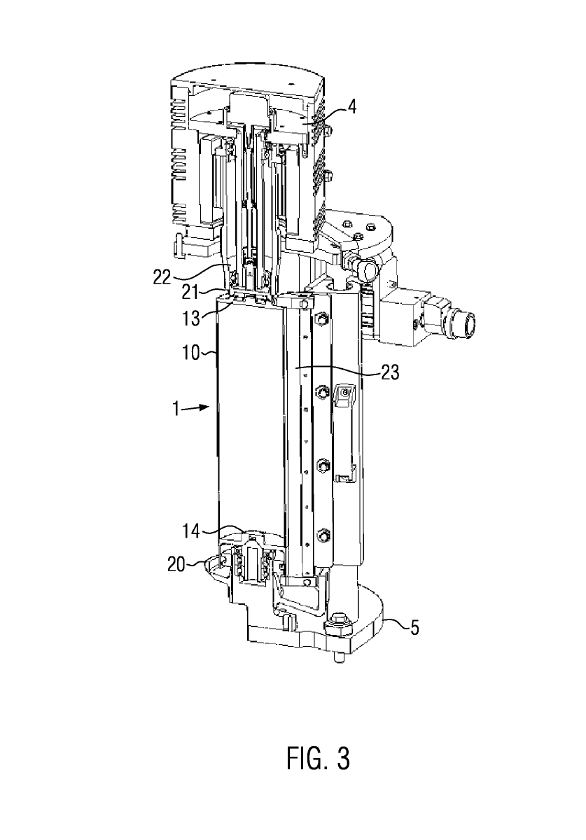

FIG. 3 shows the example of a glue roller from FIG. 2 in an installed position in an example of the gluing unit. The centering tip 20 of the mounting device is there also visible. The glue roller 1 is via this centering tip 20 mounted on a support structure 5.

Also visible is the gear ring 21 of the motor 4 which is in connection with the gearing elements 13 of the glue roller 1, so that the torque can be transferred from the motor 4 to the glue roller 1.

The motor 4 can be in particular a servo motor or a stepper motor.

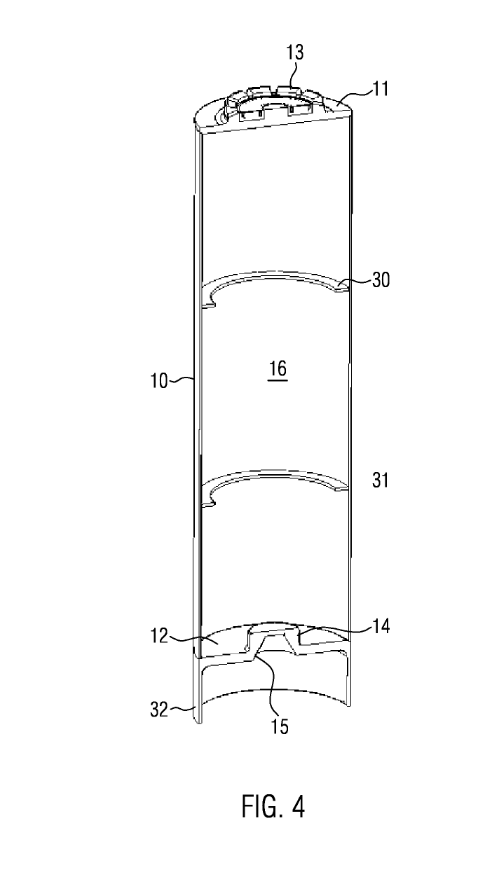

FIG. 4 shows a cross-section through a further example of a glue roller. In the interior 16 of the example of this glue roller 1, stiffening rings 30, 31 are arranged to reinforce the thin-walled jacket 10. Apart from the stiffening rings 30, 31, the interior 16 of the glue roller 1 can be hollow.

The above-described glue rollers can be manufactured, for example, according to one of the following methods.

According to a first method, a thin-walled tube, in particular made of stainless steel, can be provided having a thickness or a wall thickness of 1.5 mm to 3 mm. At both ends, this tube is then welded closed with a lid plate, in particular by laser-welding. Optionally, one or more stiffening rings can be welded in at the inner side of the tube to reinforce the cylindrical jacket surface. Foaming up the tube is also conceivable.

After welding, a gearing can be attached on one of the lid plates, in particular a Hirth-type serration. For example, a centering tip can be attached to the other lid plate.

The glue roller thus obtained can then be rotated between tips. The roller can also be ground.

Finally, hard-chroming occurs. This can occur either to the final dimension or optionally with subsequent grinding.

According to a second alternative, the glue roller can be manufactured using carbon-reinforced plastic. Here as well, hard-chroming of at least the outer side of the glue roller can subsequently occur.

For precisely wiping off the glue, a sharp edge (if possible without a radius) is necessary at the edges of the cylinder surface. For this, a provided CFRP tube can have a respective steel ring wrapped inside, which is together with the CFRP ground to the required diameter.

The glue rollers described above have a low moment of inertia about the axis of rotation. This also allows for a smaller dimensioning of the drive motor at the same time having a high momentum. The low weight of the glue roller can also contribute to an ergonomic advantage during replacement.

It is understood that the features mentioned in the embodiments described above are not restricted to these specific combinations and are also possible in any other combination.

1. A glue roller for a labeling apparatus, comprising a cylindrical jacket, the top and the bottom openings of which each have a lid plate arranged, one of said lid plates comprises a gearing for connecting said glue roller with a drive motor, and said other lid plate comprises one or more elements for connecting said glue roller with a mounting device of a labeling apparatus, and wherein said one or more elements is arranged on the side of said lid plate facing outwardly.

2. The glue roller according to claim 1, wherein said lid plate for connecting said glue roller with a mounting device comprises one of a centering tip or a receiving cone as a counterpart to a centering tip of said mounting device.

3. The glue roller according to claim 1, wherein foam can be arranged in the interior of said glue roller.

4. The glue roller according to one of the claim 1, wherein said glue roller is hollow.

5. The glue roller according to claim 1 one of the preceding claims, wherein said cylindrical jacket has a thickness of 1 mm to 5 mm.

6. The glue roller according to claim 1 wherein said lid plates are welded to said cylindrical jacket.

7. The glue roller according to claim 1, wherein one or more stiffening elements, are arranged at the inner side of said cylindrical jacket.

8. The glue roller according to claim 1, wherein at least the outer side of said cylindrical jacket is hard-chromed.

9. The glue roller according to claim 1, wherein at least said cylindrical jacket comprises carbon-fiber-reinforced plastic.

10. The glue roller according to claim 9, wherein at least one ring-shaped element made of metal, in particular steel, is incorporated into said carbon-fiber-reinforced plastic, and wherein said at least one ring-shaped element is disposed in the region of an upper edge or a lower edge of said cylindrical jacket.

11. A method for manufacturing a glue roller, according to claim 1, comprising the steps of:
providing a cylindrical tube;
connecting, a respective lid plate to said cylindrical tube at each of its two openings;
forming a gearing for connection to a drive motor at a lid plate; and
forming one or more connecting elements for connecting said glue roller with a mounting device of a labeling apparatus on said other lid plate.

12. The glue roller according to claim 1, wherein the gearing comprises a Hirth-type serration.

13. The glue roller according to claim 3, where said foam fills the entire cavity in the interior of said glue roller.

14. The glue roller according to claim 5, wherein the thickness is from 1.5 mm to 3 mm.

15. The glue roller according to claim 7, wherein the one or more stiffening elements comprise stiffening rings.

16. The glue roller according to claim 10, wherein the metal comprises steel.

17. The method according to claim 11, wherein connecting said respective lid plate to said cylindrical tube comprises welding.
